(19) United States
(12) Patent Application Publication
(10) Pub. No.: US 2012/0106848 A1
(43) Pub. Date: May 3, 2012

(54) System And Method For Assessing Photgrapher Competence

(76) Inventors: Darryl Greig, Bristol (GB); Yuli Gao, Polo Alto, CA (US); Andrew Carter, Hampshire (GB)

(21) Appl. No.: 13/260,352

(22) PCT Filed: Sep. 16, 2009
(86) PCT No.: PCT/US09/57060

§ 371 Date: Jan. 19, 2012

(51) Int. Cl. G06K 9/68; G06K 9/46

(52) U.S. Cl. 382/195; 382/218

(57) ABSTRACT

A method for automatically assessing the competence of a photographer includes assigning a competency level to the photographer based on a statistical comparison of image features between a collection of the photographer's images and a collection of high competency images. Service and product offerings can be tailored to the photographer based on the competency level assigned by the statistical comparison.

### BACKGROUND

The rapid growth of photo sharing website and print service providers has resulted in a relatively new and difficult problem—namely the management of a large number of photographers with different needs and usage characteristics. Despite significant advances in the field of computer vision, little has been done to automatically manage photographers and photo collections based on photographer understanding and competence, partly due to the high computational cost of extracting photographer-specific image features.

For example, even though providers have an increasing array of automatic tools at their disposal to enhance the final output of a photograph, such as auto-crop, lighting correction, deblurring, redeye reduction, and the like, little has been done to tailor the availability and usage of these tools based on a photographer's competence. In many cases, such tools have input parameters governing the “aggressiveness” of the operation of the tool, with the most striking results being achieved on relatively low quality images using very aggressive input parameters. It would likely be detrimental for providers to degrade high quality images taken by a professional photographer using their enhancement tools, and in some cases a tool with aggressive input parameters applied to a high quality image will do just that. The result is that providers tend to choose fairly conservative settings for their automatic tools so as to minimize the chance of degrading good images.

A further problem is how to tailor other offerings made available to users. Services for storing and processing collections of photographs from individuals are often subsidized by advertising or product suggestions. Advertising of different merchandise is more likely to be effective when targeted at a known competency group. For example, an amateur photographer is unlikely to be interested in advertisements for professional grade photography equipment and supplies. Tutorial advice that may be welcomed by a low competency user is likely to have a negative effect on a professional photographer.

### BRIEF DESCRIPTION OF THE DRAWINGS

Various features and advantages of the present disclosure will be apparent from the detailed description which follows, taken in conjunction with the accompanying drawings, which together illustrate, by way of example, features of the present disclosure, and wherein:

FIG. 1 is a schematic view of an embodiment of a system for automatically assessing the competence of a photographer and tailoring services and products offered to the photographer based on the photographer's competence;

FIG. 2 is a flow chart outlining the steps in one embodiment of a method for automatically assessing the competence of a photographer; and

FIG. 3 is a schematic view of another embodiment of a system for automatically assessing the competence of a photographer and tailoring services and products offered to the photographer based on the photographer's competence;

FIG. 4 is a flow chart outlining the steps in another embodiment of a method for automatically assessing the competence of a photographer; and

FIG. 5 is a flow chart outlining the steps in one embodiment of a method for tailoring services and products offered to a photographer.

### DETAILED DESCRIPTION

Reference will now be made to exemplary embodiments illustrated in the drawings, and specific language will be used herein to describe the same. It will nevertheless be understood that no limitation of the scope of the present disclosure is thereby intended. Alterations and further modifications of the features illustrated herein, and additional applications of the principles illustrated herein, which would occur to one skilled in the relevant art and having possession of this disclosure, are to be considered within the scope of this disclosure.

As used herein, directional terms, such as “top,” “bottom,” “front,” “back,” “leading,” “trailing,” etc, are used with reference to the orientation of the figures being described. Because components of various embodiments disclosed herein can be positioned in a number of different orientations, the directional terminology is used for illustrative purposes only, and is not intended to be limiting.

As used herein, the term “computer” refers to any type of computing device, including a personal computer, mainframe computer, portable computer, PDA, smart phone, or workstation computer that includes a processing unit, a system memory, and a system bus that couples the processing unit to the various components of the computer. The processing unit can include one or more processors, each of which may be in the form of any one of various commercially available processors. Generally, each processor receives instructions and data from a read-only memory (ROM) and/or a random access memory (RAM). The system memory typically includes ROM that stores a basic input/output system (BIOS) that contains start-up routines for the computer, and RAM for storing computer program instructions and data.

A computer typically also includes input devices for user interaction (e.g., entering commands or data, receiving or viewing results), such as a keyboard, a pointing device (e.g. a computer mouse), microphone, camera, or any other means of input known to be used with a computing device. The computer can also include output devices such as a monitor or display, projector, printer, audio speakers, or any other device known to be controllable by a computing device. In some embodiments, the computer can also include one or more graphics cards, each of which is capable of driving one or more display outputs that are synchronized to an internal or external clock source.

The term “computer program” is used herein to refer to machine-readable instructions, stored on tangible computer-readable storage media, for causing a computing device including a processor and system memory to perform a series of process steps that transform data and/or produce tangible results, such as a display indication or printed indicia.

The terms “computer-readable media” and “computer-readable storage media” as used herein includes any kind of memory or memory device, whether volatile or non-volatile, such as floppy disks, hard disks, CD-ROMs, flash memory, read-only memory, and random access memory, that is suitable to provide non-volatile or persistent storage for data, data structures and machine-executable instructions. Storage devices suitable for tangibly embodying these instructions and data include all forms of non-volatile memory, including, for example, semiconductor memory devices, such as EPROM, EEPROM, and flash memory devices, magnetic disks such as internal hard disks and removable disks, magneto-optical disks, and optical disks, such as CD, CDROM, DVD-ROM, DVD-RAM, and DVD-RW. Any of the above types of computer-readable media or related devices can be associated with or included as part of a computer, and connected to the system bus by respective interfaces. Other computer-readable storage devices (e.g., magnetic tape drives, flash memory devices, and digital video disks) also may be used with the computer.

As used herein, the terms “high competence image”, “high competency images” refer to a level of expertise that is generally associated with a professional image maker or photographer. As such the terms “high competence”, “high competency”, and “professional” may be used interchangeably throughout the description herein.

As used herein, the terms “low competence image”, “low competency images” refer to a level of expertise that is generally associated with an amateur image maker or photographer. As such the terms “low competence”, “low competency”, and “amateur” may be used interchangeably throughout the description herein.

The exemplary embodiments described herein generally provide for a system and method for providing tailored services and product offerings to a photographer based on an automatic assessment of the competency level of the photographer. The competency of the photographer is determined by statistically comparing features of a set of photographs taken by the photographer against similar features of a set of photographs taken by a professional photographer. Once the competency level of the photographer has been determined, a photography services provider, such as professional printers, can tailor the services and products offered to the photographer according to the photographer's competency level.

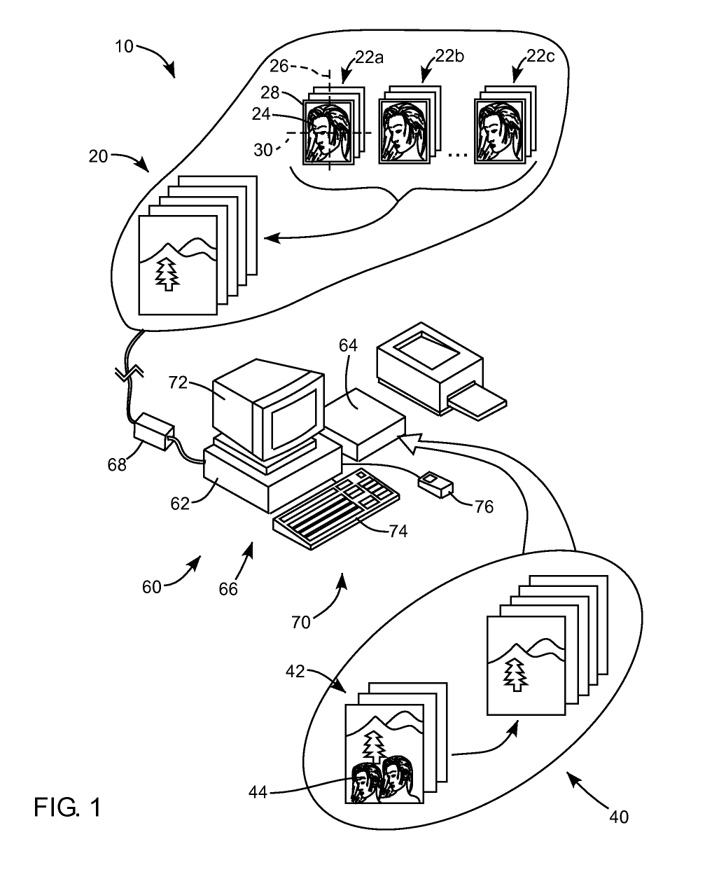

Provided in FIG. 1 is a schematic view of one embodiment of a system for tailoring services and products offered to a photographer, indicated generally at 10. The system 10 can include a collection of high competency images, indicated generally at 20, a collection of the photographer's images, indicated generally at 40, and a computer system, indicated generally at 60.

The collection of high competency images 20 can include images produced by at least one professional photographer. In one embodiment, the collection of high competency images can include images from the portfolios of multiple professional photographers. Such portfolios can be stored on photo sharing websites. In this case, the professionalism or high competency (HC) of the photographer can be assured by selecting images, or portfolios of images from moderated photography groups of sufficient skill level, whose membership is controlled by the moderator.

The collection of high competency images 20 can include a variety of subject matter, including landscapes, still life, and people. The collection of high competency images includes a plurality of subsets of face images, indicated generally at 22a, 22b . . . 22i, having a face 24 or faces of subjects of the composition. The face images 22 can include images of portraits, profiles, full body photos, midriff photos, and photos of groups of people. The faces 24 in these photos can be oriented at different angles and rotations with respect to a vertical axis, indicated by the dashed line 26, of the image. Additionally, the faces 24 can, be located anywhere within the boundary 28 of the image and can fill any percentage of the area contained within the boundary of the image.

The collection of the photographer's images 40 can include images from a photographer's personal camera or other image capturing device, such as a cell phone, video camera, and the like. The images can also include a variety of subject matter, including landscapes, still life, and people. The collection of the photographer's images includes a subset of face images, indicated generally at 42, having a face or faces 44 of subjects of the composition. The face images can include faces with the varying size, location, orientation, and rotation in the images similar to the collection of high competency images 20 described above.

It will be appreciated that statistical differences can be determined between composition layout of photographs taken by professional photographers and photographs taken by amateur photographers. For example, the placement of subjects in general, and people in particular, can be used as a differentiator between HC and LC photographers. More specifically, it has been found that a HC photographer may change the vertical face placement depending on face size. In contrast, a LC photographer generally tends to place smaller faces lower in the photograph boundary. As another example, usage of the portrait aspect ratio (image width is less than the image height) is significantly higher among HC photographers as compared to LC photographers.

Other image feature parameters have also shown significant trends between HC and LC photographers. For example, collections of professional images exhibit significantly greater usage of off-axis face poses than a collection of amateur images. Additionally, the amateur collection tends to have faces centered horizontally in both landscape and portrait aspect ratios, while the collection of high competency images exhibits a much greater usage of the available horizontal axis, indicated by a dashed line at 30, in landscape ratio. Other trends between professional and amateur photographers can also be used in the methods for determining the competency of a photographer of unknown ability, as described below.

The system can also include a computer 60 with a computer processor 62 and a system memory 64. In one embodiment, the computer can be a desktop personal computer, indicated generally at 66, or laptop (not shown) personal computer. The computer can be Internet enabled by a modem 68 or wireless connection so as to be able to link to web based photo sharing websites. In this way, the computer can gain access to portfolios of professional photographers in order to generate the collection of high competency images 20. Additionally, the collection of the photographer's images can be stored on the system memory 64 and uploaded to a web based photo sharing website.

The processor 62 can include a multi-view face detection program. The processor 62 can employ the multi-view face detection program to identify images that include a face or faces, and analyze image features of the faces in the collection of high competency images 20 and the collection of photographer's images 40. Advantageously, multi-view face detection is currently applied by many image sharing providers to all images in their databases. Additionally, many camera manufacturers embed face detection results in the image EXIF data at the time of image capture. Consequently, multi-view face detection data is readily available and can often be obtained with only minimal extra processing.

The image features that can be determined by the multi-view face detection program can include face meta-data. Face meta-data can include measurable information about a face in an image. For example, face meta-data can include whether the face or faces in an image have an off-axis face pose, use a landscape aspect ratio or a portrait aspect ratio, the relative position of a face along a horizontal axis of an image, the relative position of a face along a vertical axis of an image, a percentage of an image area covered by the sum of bounding box areas of all faces detected in an image, whether an image has multiple faces or a single face, and the like.

The use by the computer processor 62 of a multi-view face detection program provides several advantages to the embodiments described herein. For example, face detection assessment of photographer competency can be combined with other methods for determining competency not based on image analysis, such as examining EXIF data. Additionally, face detection assessment can also be combined with methods of image analysis other than face detection to ensure a robust competency determination of a particular photographer. Yet another advantage is that the methods are entirely based on image content and thus do not require external information. Consequently, the evaluation of a photographer can be accomplished in a way that is transparent to the photographer.

The processor 62 can also include a statistical analysis program that can analyze and compare the face meta-data of the collection of the photographer's images 40 to the face meta-data of the collection of high competency images 20. By use of the statistical program, the processor 62 can analyze and compare the two collections of images in a series of steps. For example, the collection of high competency images 20 can be analyzed first to determine the image features of an image that reflects a high level of competency on the part of the image maker. When the high competency (HC) image features are known, the collection of the photographer's images 40 can be analyzed for use of similar image features. The statistics from each of the collections can then be statistically compared by the processor 62, and a competency of the photographer can be assigned by the processor 62 based on the results of the comparison.

The step of analyzing the collection of high competency images 20 can include using the multi-view face detector on a large collection of images produced by professional photographers that contain faces. The collection can be large enough to provide a statistically robust population for determining HC image features. The output meta-data from the multi-view face detector can then be agglomerated by the processor 62 to produce joint density estimates and summary statistics for the size, pose, location, and rotation of faces within the collection. A clustering algorithm can be used by the processor 62 to divide the images into different categories based on one of the image features, for example the face count. The marginal and joint distributions of horizontal and vertical face center locations for each cluster can then be approximated, which amounts to conditioning on the number of faces in the image. Clustering and approximation of the marginal and joint distributions can also be performed by the processor 62 for other image features.

Once the data from the collection of high competency images 20 has been analyzed, the results can be stored and used repeatedly for comparison to collections of images from unknown photographers in order to determine the photographer's competence. Hence, the step of evaluating the collection of high competency images would only need to be done once. However, a new collection of high competency images may be compiled and analyzed periodically in order to update the statistics for changing trends in the photography industry.

As noted above, the collection of high competency images 20 can include images from the portfolios of multiple professional photographers. The images from each photographer can form subsets or sub-collections (shown at 22a, 22b . . . 22i) within the collection of high competency images 20. Each subset can be analyzed for summary statistics as described above and each subset can form a single data point for comparison to the collection of the photographer's images 40. In this way, the data points from the subsets can create the joint distributions for the collection of high competency images.

Thus, in one embodiment, the collection of high competency images can include not less than 20 subsets from professional photographers, so that at least 20 data points are created from the collection of high competency images that can be used in comparison with the collection of the photographer's images. It will be appreciated that the more subsets that are included in the collection of high competency images, the more data points that will be available for comparison with the collection of the photographer's images, and the more robust the comparison analysis. Hence, a collection of high competency images containing several hundred subsets can provide a statistically robust set of data points for use in comparison with the collection of the photographer's images.

The collection of the photographer's images 40 can be analyzed in a way similar to the collection of high competency images 20 in order to obtain summary statistics that can be compared to the benchmark statistics of the professional images to determine the competency level of the unknown photographer. However, in analyzing the collection of the photographer's images 40, some of the collected statistics from the analysis of the collection of high competency images 20 can be used to modify or drive the analysis process of the collection of the photographer's images.

Thus, in one embodiment, the multi-view face detector can also be used on the subset 42 of the collection of the photographer's images 40 that contain faces. The output meta-data from the multi-view face detector can then be agglomerated by the processor 62 to produce summary statistics for the size, pose, location, and rotation of faces within the collection. Statistical representatives, such as mean, median, medoid, and the like, of the clustering from the collection of high competency images 20 can be used by the processor 62 as representative points to generate a probability that the statistical representatives might be found from the collection of high competency images 20. The processor 62 can accomplished this by using any well known classification technique such as k-nearest neighbor, k-medoids, SVM, and the like.

The statistical analysis program employed by the processor 62 can also assign a competency level to the photographer based on the statistical comparison between the statistics collected on the collection of high competency images 20 and the statistics collected on the collection the photographer's images 40. The comparison can include testing of a set of hypotheses that the collection of the photographer's images is statistically different or statistically similar to the collection of high competency images.

It will be appreciated that a statistical hypothesis test estimates the probability that a measured quantity (i.e. the summary statistics, which are the same as the statistics corresponding to the base line statistics) is observed from a known distribution. That is, a statistical hypothesis test assumes the photographer is a professional photographer, then computes the probability that this assumption holds. If the probability is too low, the assumption is rejected and the photographer can be classified as a low competency photographer. Hence, a variety of statistical comparison techniques can be used to test the hypotheses that the collection of the photographer's images is the same as the collection of high competency images in order to compare the statistics from the two collections.

For example, a test that compares the probability of a detected face being in profile mode in the two collections can be undertaken with a standard z-test or t-test on the difference of proportions. Using such tests, the statistical comparison between the collection of the photographer's images 40 and the collection of high competency images 20 can include testing the statistical differences in the proportion of off-axis faces between the collections, statistical difference in the proportion of images in landscape aspect ratio between the collections, statistical difference in the proportion of images in portrait aspect ratio between the collections, statistical difference in the variance of horizontal face centers in landscape aspect ratio between the collections, statistical difference in the vertical location of faces between the collections, and combinations thereof.

As another example, the processor 62 can use Bayes' Theorem to formulate the probability that a user belongs to a particular competency level. For example, assuming that the observations in a collection are independent conditional on the photographer type, then:

$$P ( {I}_{0} , … , {I}_{n} \vert T = t ) = {\prod }_{i = 0}^{n} P ( {I}_{i} \vert T = t ) . \qquad ( 1 )$$

where I represents a single image by four features defined as the image aspect ratio (R), the number of faces in the image (F), the percentage of total image area (A) covered by those faces, and the vertical center (Y) of the minimum bounding box surrounding all the detected face boxes; the term {I₀, . . . , Iₙ} is a collection of images from a particular photographer; and T is the type of user. Also assuming that the vertical face center Y is normally distributed conditional on T, F, A and R, by applying Bayes' Theorem:

$$\begin{matrix}P ( T = t \vert {I}_{0} , … , {I}_{n} ) = \frac{P ( {I}_{0} , … , {I}_{n} \vert T = t ) P ( T = t )}{P ( {I}_{0} , … , {I}_{n} )} \\ = \frac{P ( T = t ) {\prod }_{i = 0}^{n} P ( {I}_{i} \vert T = t )}{P ( {I}_{0} , … , {I}_{n} )}\end{matrix} . \qquad ( 2 )$$

The argument of the product can further be expanded using the principle of conditional probability such that:

P(I|T=t)=P(P|R,F,A,T=t)P(R,F,A|T=t). (3)

Under the assumption of normality, the first term on the right hand side of (3) is a normal density function, whose mean and variance may be estimated from a dataset. If the face area percentage is rounded to integer values, then the second term in (3) is a discrete joint distribution with at most 200f entries where f is the maximum number of faces in a single image. This distribution can also be estimated by the relative frequencies of R, F and A combinations.

Even with a fairly large set there are quite a number of parameters to estimate in this approach, and in practice the data may be too sparse for some combinations to produce reliable estimates. This can be overcome to some extent by collecting a much larger dataset. An alternative to collecting a larger dataset would be to compute an approximate 95% confidence interval for each parameter estimate (e.g. by estimating the confidence interval of the mean) and restrict analysis to those parameters with sufficiently small confidence intervals. For example, in one case it was found that the estimated mean vertical face position for portrait oriented images with 9 faces covering 12% of the image area was 0.62, but the estimated 95% confidence interval of the mean was [0.28,0.96] indicating very low confidence in this estimate. Therefore, in this case, any images of this type would be excluded from the final analysis.

Assuming a two-class classification problem, such as the unknown photographer is either high competence (HC) or low competence (LC), the denominator in equation (2) may be computed by summing the conditional probabilities P(I₀, . . . , Iₙ|T), for T=HC and T=LC. Thus, the only remaining parameter to estimate is the prior probability that a photographer is highly competent, P(T=HC). The prior probabilities are dependent entirely on the photographer population chosen. Normally one would expect there to be many more LC photographers than HC ones, but some websites may have a higher than normal proportion of photographers with professional level competency. In general, since datasets can be chosen for which HC and LC photographers occur at about the same rate, prior probability can simply be set to 0.5 for both cases. However, it is desirable that prior probability be tailored for specific implementations. The prior probabilities can also be used as cost parameters to bias towards one or the other of the categories depending on the perceived cost of misclassification.

It turns out that the product in equation (2) can become numerically unstable even for quite small values of n, so the log transform of the product can be computed instead, and then converted back at the end in order to obtain a probability estimate. This also serves to simplify the computation since the conditional density function of Y is normal and thus is an exponential function.

Advantageously, estimating the probability that an unknown photographer is of a particular skill level can be done very quickly using the method described above. For example, in one case, un-optimized code took an average of 300 ms per photographer for 334 photographers with an average of 582 images each. Additionally, the multi-view face detector requires somewhat less than 100 ms per image on a standard PC. Thus, under these conditions, a photographer's collection with around 1000 images could be processed in less than about 2 minutes.

Returning to FIG. 1, the processor 62 can also include a user interface, indicated generally at 70, such as a monitor 72, keyboard 74, and mouse 76. The user interface 70 can provide a way for a provider to offer the photographer a plurality of services and products based on the competency level of the photographer as assigned by the processor 62. In one example, the services and products offered the photographer can include a plurality of automatic image enhancement tools with settings for different levels of photographer competence. As another example, the services and products may be offered as advertisements effectively targeted at different levels of photographer competence. As yet another example, the services and products may include support and tutorial advice effectively targeted at different levels of photographer competence. In each example, the provider can transparently tailor the services specifically to the skill level of the photographer's competence.

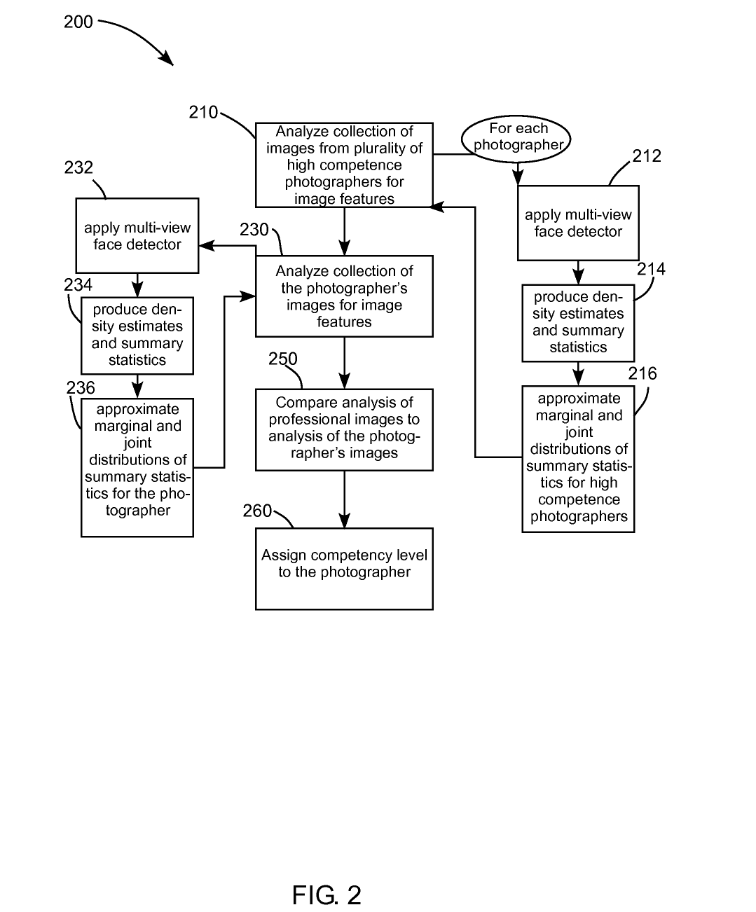

Provided in FIG. 2 is a flow chart outlining the steps in one embodiment of a method for automatically assessing the competence of a photographer. The method, indicated generally at 200, coincides with the system 10 described above and shown in FIG. 1, and can be carried out by a computer having a processor and system memory, and can include analyzing a collection of high competency images for statistically significant image features, as shown at 210. A collection of the photographer's images can be analyzed for image features corresponding to the statistically significant image features of the collection of high competency images, as shown at 230. A competency level can be assigned to the photographer based on a statistical comparison of image features between the collection of the photographer's images and the collection of high competency images, as shown at 250.

The method can also include providing service and product offerings to the photographer based on the competency level assigned by the statistical comparison, as shown at 260. The services and products offered the photographer can include a plurality of automatic image enhancement tools with settings for different levels of photographer competence, advertisements effectively targeted at different levels of photographer competence, and support and tutorial advice effectively targeted at different levels of photographer competence.

The step of analyzing the collection of high competency images 210 can also include applying a multi-view face detector to a statistically robust population of images containing faces produced by at least one professional photographer, as shown at 212. Data from the multi-view face detector can be agglomerated to produce density estimates and summary statistics for size, pose, and location of faces within the images, as shown at 214. The images can be divided into different categories based on face size to define area based clusters, as shown at 216. The marginal and joint distributions can be approximated for image features from the face detector as number of faces present, total proportion of image area covered by faces, horizontal face center location, vertical face center location, position of profiles, position of portraits, and combinations these image features, as shown at 218.

The step of analyzing the collection of photographer's images 230 can include applying a multi-view face detector to face images in the collection of the photographer's images, as shown at 232. Data from the multi-view face detector can be agglomerated to produce density estimates and summary statistics for size, pose, and location of faces within the face images, as shown at 234.

A classification of the face images can be driven by using statistical markers from the analysis of the collection of high competency images as representative points in a statistical classification technique on the face images, as shown at 236. The statistical markers from the analysis of the collection of high competency images can include the mean, medoid, median, and another statistical representative points on the face images. The statistical classification technique can include k-nearest neighbor, k-medoids, SVM, and the like.

The marginal and joint distributions can be approximated for image features from the face detector as number of faces present, total proportion of image area covered by faces, horizontal face center location, vertical face center location, position of profiles, position of portraits, and combinations these image features, as shown at 238.

The step of assigning a competency level to the photographer 250 can include a statistical comparison of image features between the collection of the photographer's images and the collection of high competency images. The comparison can include testing a hypothesis or set of hypotheses such as the statistical differences in the proportion of off-axis faces between the collections, the proportion of images in landscape aspect ratio between the collections, the proportion of images in portrait aspect ratio between the collections, the variance of horizontal face centers in landscape aspect ratio between the collections, and the vertical location of faces between the collections. Additionally, as described above, these statistical differences can be tested using a statistical technique such as Baye's Theorem, the principle of conditional probability, and the like.

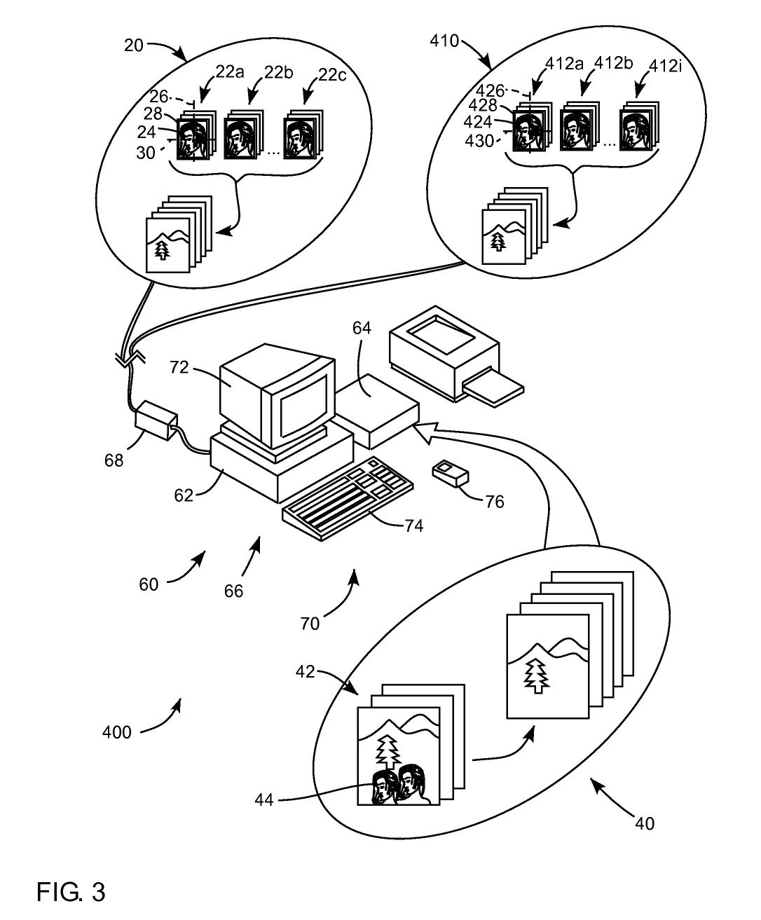

Provided in FIG. 3 is a schematic view of another embodiment of a system for tailoring services and products offered to a photographer, indicated generally at 400. The system 400 can be similar in many respects to the system 10 described above and shown in FIG. 1. The system 400 can include a collection of high competency images, indicated generally at 20, a collection of the photographer's images, indicated generally at 40, and a computer system, indicated generally at 60. The system 400 can also include a collection of low competency images, indicated generally at 410.

The collection of high competency images 20 can include images produced by at least one professional photographer. In one embodiment, the collection of high competency images can include images from the portfolios of multiple professional photographers. Such portfolios can be disposed on photo sharing websites. In this case, the professionalism or high competency (HC) of the photographer can be assured by selecting images, or portfolios of images from moderated photography groups of sufficient skill level, whose membership is controlled by the moderator.

Once again, the collection of high competency images 20 can include a variety of subject matter, including landscapes, still life, and people. The collection of high competency images includes a plurality of subsets of face images, indicated generally at 22a, 22b . . . 22i, having a face 24 or faces of subjects of the composition. The face images 22 can include images of portraits, profiles, full body photos, midriff photos, and photos of groups of people. The faces 24 in these photos can be oriented at different angles and rotations with respect to a vertical axis, indicated by the dashed line 26, of the image. Additionally, the faces 24 can be located anywhere within the boundary 28 of the image and can fill any percentage of the area contained within the boundary of the image.

The collection of low competency images 410 can also include images produced by at least one low competency or amateur photographer. In one embodiment, the collection of low competency images can include images from the portfolios of multiple amateur photographers. Such portfolios can also be disposed on un-moderated photo sharing websites.

The collection of low competency images 410 can include a variety of subject matter, including landscapes, still life, and people. The collection of low competency images includes a plurality of subsets of face images, indicated generally at 412a, 412b . . . 412i, having a face 424 or faces of subjects of the composition. The face images 412 can include images of portraits, profiles, full body photos, midriff photos, and photos of groups of people. The faces 424 in these photos can be oriented at different angles and rotations with respect to a vertical axis, indicated by the dashed line 426, of the image. Additionally, the faces 424 can be located anywhere within the boundary 428 of the image and can fill any percentage of the area contained within the boundary of the image.

The collection of the photographer's images 40 can include images from a photographer's personal camera or other image capturing device, such as a cell phone, video camera, and the like. The images can include a variety of subject matter, including landscapes, still life, and people. The collection of the photographer's images includes a subset of face images, indicated generally at 42, having a face or faces 44 of subjects of the composition. The face images can include faces with the varying size, location, orientation, and rotation in the images similar to the collection of high competency images 20 described above.

The system can also include a computer 60 with a computer processor 62 and a system memory 64. In one embodiment, the computer can be a desktop personal computer, indicated generally at 66, or laptop (not shown) personal computer. The computer can be Internet enabled by a modem 68 or wireless connection so as to be able to link to web based photo sharing websites. In this way, the computer can gain access to portfolios of professional photographers 20 in order to generate the collection of high competence images 20, and portfolios of amateur photographers to generate the collections of low competence images 410. Additionally, the collection of the photographer's images can be stored on the system memory 64 and uploaded to a web based photo sharing website.

The processor 62 can include a multi-view face detection program. The processor 62 can employ the multi-view face detection program to identify images that include a face or faces, and analyze image features of the faces in the collection of high competence images 20, the collection of low competence images 410, and the collection of photographer's images 40.

The image features that can be determined by the multi-view face detection program can include face meta-data. Face meta-data can include measurable information about a face in an image. For example, face meta-data can include whether the face or faces in an image have an off-axis face pose, use a landscape aspect ratio or a portrait aspect ratio, the relative position of a face along a horizontal axis of an image, the relative position of a face along a vertical axis of an image, a percentage of an image area covered by the sum of bounding box areas of all faces detected in an image, whether an image has multiple faces or a single face, and the like.

The processor 62 can also include a statistical analysis program that can analyze and compare the face meta-data of the collection of the photographer's images 40 to the face meta-data of the collection of high competence images 20, and the collection of low competence images 410. By use of the statistical program, the processor 62 can analyze and compare the collection of the photographer's images to the collection of high competence images and the collection of low competence images in a series of steps. For example, the collection of high competence images 20 can be analyzed first to determine the image features of an image that reflects a high level of competency on the part of the image maker. Similarly, the collection of low competence images 410 can be analyzed to determine the image features of an image that reflect a low level of competency on the part of the image maker. When the high competency (HC) and low competency (LC) image features are known, the collection of the photographer's images 40 can be analyzed for use of similar image features. The statistics from each of the collections can then be statistically compared by the processor 62, and a competency of the photographer can be assigned by the processor 62 based on the results of the comparison.

The method for analyzing the collection of high competency images 20 and collection of low competency images 410 can include using the multi-view face detector on large collections of images produced by either professional or amateur photographers that contain faces. The collections can be large enough to provide a statistically robust population for determining HC and LC image features. The output meta-data from the multi-view face detector can then be agglomerated by the processor 62 to produce joint density estimates and summary statistics for the size, pose, location, and rotation of faces within the collection. A clustering algorithm can be used by the processor 62 to divide the images into different categories based on one of the image features, such as the face count in an image. The marginal and joint distributions for each cluster can then be approximated, which amounts to conditioning on the number of faces in the image. Clustering and approximation of the marginal and joint distributions can also be performed by the processor 62 for other image features.

Once the data from the collection of high competency images 20 and the collection of low competency images 410 have been analyzed the results can be stored and used repeatedly for comparison to collections of images from unknown photographers in order to determine the photographer's competence. Hence, the step of evaluating the collections of professional and amateur images would only need to be done once. However, a new collection of high competency images or amateur images may be compiled and analyzed periodically in order to update the statistics for changing trends in the photography industry.

As noted above, the collection of high competency images 20 can include images from the portfolios of multiple professional photographers. The images from each photographer can form subsets or sub-collections (shown at 22a, 22b . . . 22i) within the collection of high competency images 20. Each subset can be analyzed for summary statistics as described above and each subset can form a single data point for comparison to the collection of the photographer's images 40. In this way, the data points from the subsets can create the joint distributions for the collection of high competency images.

Thus, in one embodiment, the collection of high competency images can include not less than 20 subsets professional photographers, so that at least 20 data points are created from the collection of high competency images that can be used in comparison with the collection of the photographer's images. It will be appreciated that the more subsets included in the collection of high competency images, the more data points are available for comparison with the collection of the photographer's images, and the more robust the comparison analysis. Hence, a collection of high competency images containing several hundred subsets can provide a statistically robust set of data points for use in comparison with the collection of the photographer's images.

Similarly, the collection of low competency images 410 can include images from the portfolios of multiple amateur photographers. The images from each photographer can form subsets or sub-collections (shown at 412a, 412b . . . 412i) within the collection of high competency images 410. Each subset can be analyzed for summary statistics as described above and each subset can form a single data point for comparison to the collection of the photographer's images 40. In this way, the data points from the subsets can create the joint distributions for the collection of high competency images.

Thus, in one embodiment, the collection of low competency images can include not less than 20 subsets professional photographers, so that at least 20 data points are created from the collection of low competency images that can be used in comparison with the collection of the photographer's images. It will be appreciated that the more subsets that are included in the collection of low competency images, the more data points will be available for comparison with the collection of the photographer's images, and the more robust the comparison analysis. Hence, a collection of low competency images containing several hundred subsets can provide a statistically robust set of data points for use in comparison with the collection of the photographer's images.

The collection of the photographer's images 40 can be analyzed in a way similar to the collection of high competency images 20 and low competency images 410 in order to obtain summary statistics that can be compared to the benchmark statistics of the high competency images and amateur images in order to determine the competency level of the unknown photographer. However, in analyzing the collection of the photographer's images 40, some of the collected statistics from the analysis of the collection of high competency images 20 and the collected statistics from the analysis of the collection of low competency images 410 can be used to modify or drive the analysis process of the collection of the photographer's images.

Thus, in one embodiment, the multi-view face detector can also be used on the subset 42 of the collection of the photographer's images 40 that contain faces. The output meta-data from the multi-view face detector can then be agglomerated by the processor 62 to produce summary statistics for the size, pose, location, and rotation of faces within the collection. Statistical representatives, such as mean, median, medoid, and the like, of the clustering from the collection of high competency images 20 and the collection of low competency images 410 can be used by the processor 62 as representative points to generate a probability that the statistical representatives might be found from the collection of high competency images 20 or the collection of low competency images 410. The processor 62 can accomplished this by using any well known classification technique such as k-nearest neighbor, k-medoids, SVM, and the like.

The statistical analysis program employed by the processor 62 can also assign a competency level to the photographer based on the statistical comparison between the summary statistics of the collection of high competency images 20, the summary statistics of the low competency images 410, and the summary statistics of the collection of the photographer's images 40. The comparison can include testing of a set of hypotheses that the collection of the photographer's images is statistically different or statistically similar to the collection of high or low competency images.

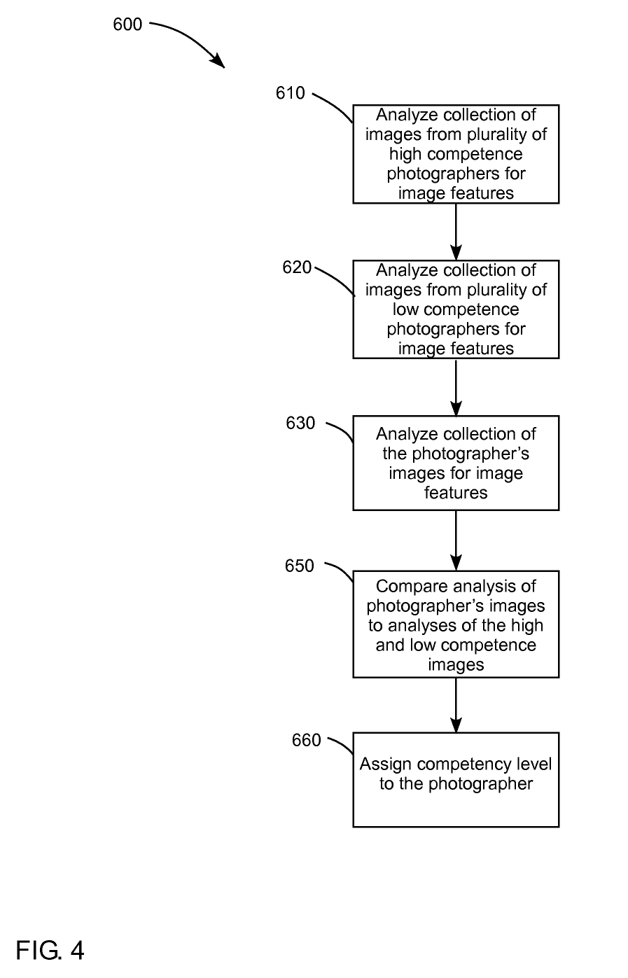

Provided in FIG. 4 is a flow chart outlining the steps in another embodiment of a method for automatically assessing the competence of a photographer. The method, indicated generally at 600, can be similar in many respects to the method 200 shown in FIG. 2 and described above. The method 600 can be carried out by a computer having a processor and system memory, and can include analyzing a collection of high competency images for statistically significant image features, as shown at 610. A collection of low competency images can also be analyzed for statistically significant features, as shown at 620. A collection of the photographer's images can be analyzed for image features corresponding to the statistically significant image features of the collections of high and low competency images, as shown at 630. The summary statistics from the collection of the photographers images can be compared to the summary statistics from the collections high and low competency images, as shown at 650, and a competency level can be assigned to the photographer based on a statistical comparison between the collection of the photographer's images and the collections of high and low competency images, as shown at 660.

It will be appreciated that a collection of a photographer's images can be used to classify the competency of the photographer by comparing summary statistics gathered from the collection of the photographer's images against similar summary statistics from a collection of high competency images and summary statistics of a collection of low competency images.

Similar to the description of the analysis of the collection of high competency images used in the system 10 and method 200 described above and shown in FIGS. 1 and 2, in the low competency comparison case, a representative set of low competency images can be used to create the same set of baseline statistics to describe low competence photographers. Thus, for any new photographer using the system 400 or the method 600, the problem can become a two-class classification problem and the photographer can be allocated to the most likely set or class, namely either a high competency (HC) class or a low competency (LC) class.

A two-class method as shown in FIG. 4 at 600 can provide a number of advantages in assessing the competence of a photographer. For example, thresholds, such as how low the probability should be to decide that photographer is low competence, do not have to be set.

Additionally, the two-class method allows use of one-sided tests as opposed to two-sided tests that are used in a one-class method. For example, it is well known that professional photographers generally position faces vertically in an image frame according to a determinable distribution, D. However, low competence photographers nearly always position faces lower in the image. If the information regarding the LC photographer is unknown, a two-sided test would be required to determine the competency of the photographer. That is, it would have to be determined whether faces in the unknown photographer's images were positioned much higher or much lower than the mean of the distribution D.

In contrast, if both the distribution D (for vertical placement of faces by professional photographers) and the information that LC photographers usually position faces lower in an image are considered, then only images with faces much lower than the mean of the distribution D need be identified to assign a competence level to the unknown photographer. Hence, a one-sided test can be used without setting thresholds and, yields acceptable results.

It will be appreciated that the steps of analyzing the various collections of images and comparing the summary statistics from each collection can be similar to the analyses and statistical comparisons described above.

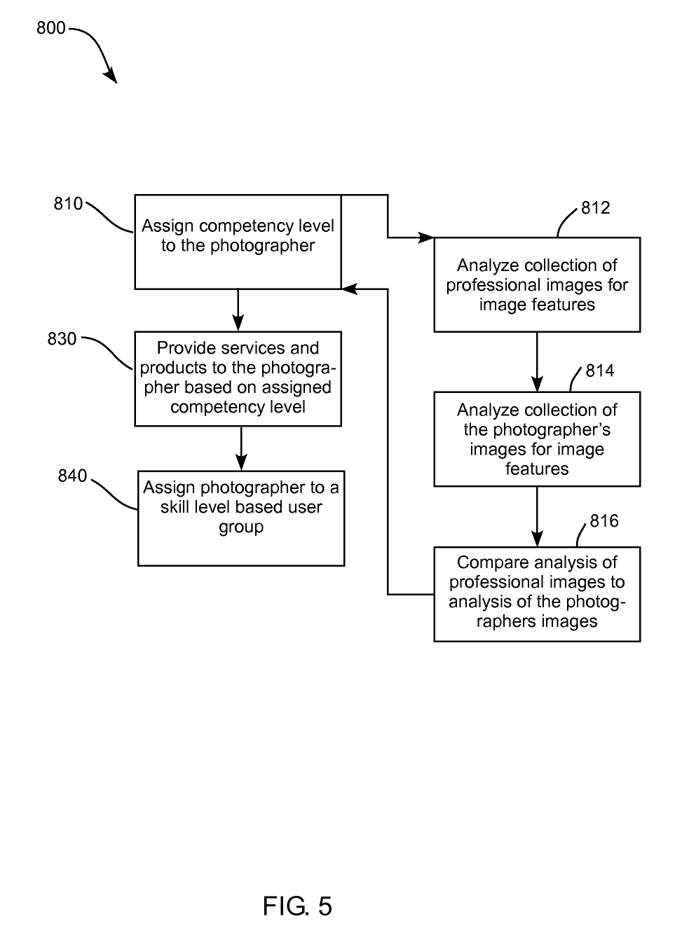

Turning to FIG. 5 a flow chart is shown outlining the steps in one embodiment of a method for tailoring services and products offered to a photographer. The method, indicated generally at 800, can be carried out by a computer having a processor and system memory, and can include assigning a competency level to the photographer based on a statistical comparison of image features between a collection of the photographer's images and a collection of high competency images, as shown at 810. Service and product offerings can be provided to the photographer based on the competency level assigned by the statistical comparison, as shown at 830.

The step of assigning a competency level to the photographer 810 can include analyzing a collection of high competency images with a multi-view face detector for statistically significant image features, as shown at 812. A collection of the photographer's images can be analyzed with the multi-view face detector for image features corresponding to the statistically significant image features of the collection of high competency images, as shown at 814. Statistical differences of image feature data can be compared between the collection of the photographer's images and the collection of high competency images with a statistical technique such as Bayes' Theorem combined with the principle of conditional probability as shown at 816.

The services offered the photographer based on the competence assigned the photographer can include automatic photo adjustments such as red eye reduction, cropping, de-blurring, sharpening, hue adjustment, balance adjustment, contrast adjustment, brightness adjustment, de-speckling, and the like. Additionally, the products offered to the photographer based on the competence assigned the photographer can include photographic equipment, photography support and tutorials, photograph printing, membership in a moderated online forum, and combinations thereof.

Additionally, the method can include automatically assigning the photographer to a skill level based user group based on the competency level assigned by the statistical comparison, as shown in 840. It will be appreciated that administrative tasks on photo sharing websites can be extremely difficult due to the sheer volume of users on such websites. For example, some photo sharing providers offer moderated professional photographer groups and forums. One of the daily tasks of the group administrator is to evaluate new users according to the competence they have demonstrated in their photo collections. When such a group increases in popularity, the administrators may struggle in sorting the qualified users from the volume of applicants seeking admission to the group. Thus, advantageously, the embodiments of the methods described herein can assist the administrators of such website groups and forums since the applicant photographers can be automatically ranked by their competence, and then automatically accepted or rejected based on a threshold competence ranking set by the group administrator. Administrators then only need to make decisions on those whose competence scores may be in an intermediate range.

In summary, the embodiments generally described herein provide for a system and method for automatically assessing the competency level of an unknown photographer based on the photographer's image collection. Print and photo service providers can then use the competency assessment ranking to tailor services and products to the skill level of the photographer. The system and method provide several advantages to both the provider and individual photographers. For example, the method is automatic and transparent to the user. Additionally, the method does not require extensive intervention on the part of the provider and may not even require modification of existing offerings made by the provider. The system and method can also be dynamically updated by re-assessing the photographer(s) based on image collection updates to allow for changes in the competence level of any given photographer. Moreover, the system and method maximize the user value of existing content and functionality offered by the providers.

It is to be understood that the above-referenced arrangements are illustrative of the application of the principles disclosed herein. It will be apparent to those of ordinary skill in the art that numerous modifications can be made without departing from the principles and concepts of this disclosure, as set forth in the claims.

What is claimed is:

1. A method for automatically assessing the competence of a photographer, the method being carried out by a computer having a processor and system memory, comprising the steps of:
analyzing a collection of high competency images for statistically significant image features;
analyzing a collection of the photographer's images for image features corresponding to the statistically significant image features; and
assigning a competency level to the photographer based on a statistical comparison of the image features between the collection of the photographer's images and the collection of high competency images.

2. A method in accordance with claim 1, further comprising:
analyzing a collection of low competency images for statistically significant image features; and
assigning a competency level to the photographer based on a statistical comparison of image features between the collection of the photographer's images, the collection of high competency images, and the collection of low competency images.

3. A method in accordance with claim 1, further comprising:
providing service and product offerings to the photographer based on the competency level assigned by the statistical comparison.

4. A method in accordance with claim 3, wherein the services and products offered the photographer are selected from the group consisting of automatic image enhancement tools with settings for different levels of photographer competence, advertisements targeted at different levels of photographer competence; and support and tutorial advice targeted at different levels of photographer competence.

5. A method in accordance with claim 1, wherein the image features include face meta-data selected from the group consisting of off-axis face poses, a landscape aspect ratio, a portrait aspect ratio, position of a face along a horizontal axis of a photograph, position of a face along a vertical axis of a photograph, percentage of image area covered by the sum of bounding box areas of all faces detected in an image, images with multiple faces, single face images, and combinations thereof.

6. A method in accordance with claim 1, wherein the step of analyzing the collection of high competency images further includes:
applying a multi-view face detector to face images containing faces produced by a plurality of photographers classified as highly competent;
agglomerating data from the multi-view face detector to produce density estimates and summary statistics for size, pose, and location of faces within the images for each of the plurality of photographers;
dividing the images into different categories based on face size to define area based clusters for each of the plurality of photographers; and
approximating the marginal and joint distributions of image features selected from the group consisting of number of faces present, total proportion of image area covered by faces, horizontal face center location, vertical face center location, position of profiles, position of portraits, and combinations thereof.

7. A method in accordance with claim 1, wherein the step of analyzing the collection of the photographer's images further includes:
applying a multi-view face detector to face images in the collection of the photographer's images;
agglomerating data from the multi-view face detector to produce density estimates and summary statistics for size, pose, and location of faces within the face images;
driving a classification of the face images by using statistical markers from the analysis of the collection of high competency images as representative points in a statistical classification technique on the face images; and
approximating the marginal and joint distributions of image features selected from the group consisting of number of faces present, total proportion of image area covered by faces, horizontal face center location, vertical face center location, position of profiles, position of portraits, and combinations thereof.

8. A method in accordance with claim 7, wherein the statistical markers from the analysis of the collection of high competency images are selected from the group consisting of mean, medoid, median, and combinations thereof; and
wherein the statistical classification technique is selected from the group consisting of k-nearest neighbor, k-medoids, SVM, and combinations thereof.

9. A method in accordance with claim 1, wherein the statistical comparison of image features between the collection of the photographer's images and the collection of high competency images includes comparing the statistical differences between the collections of characteristics selected from the group consisting of the proportion of off-axis faces, the proportion of images in landscape aspect ratio, the proportion of images in portrait aspect ratio, the variance of horizontal face centers in landscape aspect ratio, the vertical location of faces, and combinations thereof.

10. A method in accordance with claim 8, wherein the statistical difference is tested using a statistical technique selected from the group consisting of Bayes' Theorem, the principle of conditional probability, and combinations thereof.

11. A method for tailoring services and products offered to a photographer, the method being carried out by a computer having a processor and system memory, comprising the steps of:
assigning a competency level to the photographer based on a statistical comparison of image features between a collection of the photographer's images and a collection of high competency images; and
providing service and product offerings to the photographer based on the assigned competency level.

12. A method in accordance with claim 11, wherein the step of assigning a competency level to the photographer further includes:
analyzing a collection of high competency images with a multi-view face detector for statistically significant image features;
analyzing a collection of the photographer's images with the multi-view face detector for image features corresponding to the statistically significant image features; and
comparing statistical differences of image feature data between the collection of the photographer's images and the collection of high competency images with a statistical technique selected from the group consisting of Bayes' Theorem, the principle of conditional probability, and combinations thereof.

13. A method in accordance with claim 11, wherein the services offered the photographer include automatic photo adjustments selected from the group consisting of red eye reduction, cropping, de-blurring, sharpening, hue adjustment, balance adjustment, contrast adjustment, brightness adjustment, de-speckling, and combinations thereof; and
wherein the products offered the photographer are selected from the group consisting of photographic equipment, photography tutorials, photograph printing, membership in a moderated online forum, and combinations thereof.

14. A method in accordance with claim 11, further comprising:
automatically assigning the photographer to a skill level-based user group based on the competency level assigned by the statistical comparison.

15. A system for automatically tailoring services and products offered to a photographer, comprising:
a) a collection of high competency images, stored in a computer-readable storage medium, having a subset of face images;
b) a collection of the photographer's images, stored in a computer-readable storage medium, having a subset of face images; and
c) a computer processor and system memory, the processor further comprising:
i) a multi-view face detection program for analyzing face meta data from the collection of high competency images and the collection of photographer's images;
ii) a statistical analysis program for statistically comparing the face meta data to assign a competency level to the photographer based upon the statistical comparison; and
iii) a user interface for offering a plurality of services and products to the photographer based on the competency level assigned by the statistical correspondence.
